(19) United States
(12) Patent Application Publication
(10) Pub. No.: US 2006/0070277 A1
(43) Pub. Date: Apr. 6, 2006

(54) Electrical device identifier

(76) Inventor: James S. Bungerz, Westfield, NJ (US)

Correspondence Address: Ward & Olivo, 382 Springfield Avenue, Summit, NJ, 07901, US

(21) Appl. No.: 10/957,818

(22) Filed: Oct. 4, 2004

(51) Int. Cl. G09F 13/22

(52) U.S. Cl. 40/544

(57) ABSTRACT

The present invention is a device for assisting in the identification of an electrical device or electrical device peripherals via the use of an identifying marker affixed to the device or the peripheral's plug.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to adhesive markers for marking plugs of cords attached to electrical devices for the purpose of identifying an electrical device from its plug end.

2. Description of the Related Art

In residential, business and industrial settings, it has often been seen as useful to mark wires or cables such that the device they are attached to can be more easily ascertained at a later date. However, cords, cables and wires are generally not fully visible from one end to another, so it can be difficult to identify which cord or cable is attached to which particular device, even at a single electrical outlet. The problem is compounded in situations where many devices are plugged in in close proximity to one other, such as on a power strip, surge protector, or where the cables of many devices are aggregated. Consequently, devices for identifying electrical cables and wires are common, and have been for some time.

The known markers generally attach to a cable either through some method of adhesion, or can be hooked to the cable via a sleeve, collar or locking lug. Generally, these products rely on either the use of generic indicia (i.e., random numbers and/or letters) or color coding to achieve identification, (e.g., 1=TV, red=VCR cables, or AC1F=air compressor cables). These generic markers typically require that the user record the identifying data (indicia or color) on a separate or remote record away from the actual marker for future reference and safekeeping. There are also known marking systems that utilize nylon or wire ties for attachment to the cable which are equipped with stickers illustrating different electrical devices, any one of which can be affixed to the appropriate tie. Other known marking systems supply blank stickers on which the user can write the name of the desired device before attaching it to the cable marker and subsequently attaching the marker to the cable.

Each of these marking systems has its own set of disadvantages.

As a threshold matter, marking wires or cables—instead of plugs—comes with multiple drawbacks. First, the specific placement of the wire identifier can be problematic, and at worst, can completely nullify any utility the device may have had. For example, sleeves or collars holding identifying tags are often affixed at pre-determined intervals along a cable or cord but may not be located at an optimal position to allow ready access or identity. Still other marking systems do not allow the marker device to snap snugly around a wire, but merely encircle it loosely like a bangle bracelet. In this case, the wire identifier can move freely up and down the wire, and could easily slide into a position where it can no longer be seen or reached. In cases where a snap closure or adhesive is used to attach the identifier at a particular place on the wire, a different but equally problematic situation exists—as more wires are run into the same area or plugged into the same power strip, the previous placement of the identifier may no longer be optimal. Additionally, many of the known devices are bulky and create additional clutter rather than help reduce or organize it. In some cases there are several inches of additional material of the identifying apparatus left hanging off of a wire or cable, creating additional mass in an already crowded space.

In sharp contrast to these devices, the present invention is designed to be placed on a plug, thereby solving the problems associated with placing an identifying device arbitrarily along, or loosely on, a length of cord or cable.

As if marking a less than optimal item (i.e., a cable that may not even be fully visible) weren't difficult enough, the existing methods of identification are also less than ideal. Color coding may be sufficient if the only objective is to identify which wires or cables should be grouped together—for example, all green-labeled cables are associated with one device, all red-labeled wires with another—but they offer no help in specifically identifying exactly which device the green or red wires are attached to. Markers utilizing general indicia such as number and letters typically result in the same problem—they render little assistance in identifying the devices they are attached to.

Thus, many cable markers are really nothing more than exactly that—devices that differentiate cables from one another by marking or indicating which cables or cords should be grouped together. Importantly, however, they fail to help a user identify exactly what electrical device is attached to the cable. The known marking systems, even if called “identifiers,” generally are not designed such that the marker itself specifically identifies which electrical device it is attached to. This information generally can only be determined after consultation with the remote record that has been written down elsewhere, or through memorization of which marker goes with which device.

Therefore, any true “identification” of the electrical device by the known devices is a sequential step process—first, a marker with the abstract indicia or color must be attached to the cable or cord. Next, information about the item marked must be recorded at a remote location (or memorized) along with the corresponding indicia. Finally, a user must consult the remote record every time he or she wishes to know which wire or cable is associated with which electrical device or apparatus. Without the recorded or memorized data, accurate identification may not be possible, because the marker itself does not give the onlooker any specific information about the electrical device to which the marker is attached.

Thus, there is the clear need for a device which allows for a one-step “on-site” immediate identification of a device which can be placed on the device's plug. The present invention is such a device.

### SUMMARY OF THE INVENTION

The present invention consists of identification markers for use on the plugs of electrical devices. The markers are designed to be affixed directly onto the plugs and are generally useful in all locations but especially where there are multiple plugs attached in one area. The markers are easy to use and enable a one-step identification/labeling process.

The marker of the present invention will preferably consist of a small circular disk that has an adhesive material on the back and is printed, embossed, or debossed on the back or front with an image of an electrical device. The markers will attach to the electrical plugs by means of the adhesive material on the back of the disk, which can be any adhesive generally known in the art. Once attached, these markers will remain fixed upon the location until removed by the user. The images on the front of the disks will represent common household, office and industrial electrical devices such as televisions, lamps, printers, toasters, computers, copiers, telephones, clocks, etc. To use the markers, a person will simply select and attach the appropriate marker to the plug of the electrical device. Once in place, a person can immediately identify the device attached to the plug by simply viewing the marker, which will contain a self-explanatory image of the device.

Because the marker is attached to the plug itself, it can be used in all areas, especially those with limited room, such as an electrical outlet located behind a piece of furniture. In such confined areas, other labeling devices (such as wire ties or tags which are several inches in length) may become obscured or entangled. The present invention is attached with an adhesive, so there is no chance of the marker sliding up or down to a non-optimal location. In addition, because the marker is neither bulky nor consumes a significant amount of space, it can be used conveniently in outlets with multiple plugs or in surge protectors where plugs are bundled together. In fact, the invention is particularly suited to resolve the common problem of identifying the correct plug for a specific appliance at an outlet where many other plugs are connected.

The universally recognized images on the markers are illustrative representations of common household and office electrical devices, rather than anonymous symbols, numbers, or letters. Therefore, the invention does not require remotely recorded data or a reference card to decipher the meaning of the markers. Consequently, the identification of the device associated with the plug occurs immediately when the marker is viewed, not after consulting a reference card or attempting to remember which marker goes with which device. Thus, identifying plugs with the present invention involves only one step, rather than multiple steps. Furthermore, there is no need for a reference card which can be lost, thereby rendering the symbols on the markers useless.

The markers are small in size and simple in design, which facilitates their production. The circular disks for the markers can be manufactured from plastic or other similar material and can be produced either on a steel rule die cut card and punched out as needed, or individually as loose pieces. The images on the disks will be either printed in ink, embossed or debossed (in accordance with printing, embossing and debossing methods well known in the art) and will depict universally recognized symbols for a wide variety of electrical devices. For the sake of simplicity, the words “printed” or “printing” shall be use throughout this application to refer not only to printing in the conventional sense, but also embossing and debossing where applicable. The front side of the disk can be flat, concave, or convex to facilitate the viewing of the image from multiple angles. The adhesive material on the back side of the disks can be supplied by various adhesive producers—the adhesion materials appropriate for such a device are already well-known in the art.

Various other features can be incorporated into the design of the markers. Luminescent ink can be used to print the images on the disks so that they will be discernable in areas of low light (or alternatively, in complete darkness), which is convenient because electrical outlets are often located in dim areas. Luminescent plastics or polyurethanes can be used for the marker itself, allowing a symbol printed in black ink to stand out in the dark. In addition, the images may be embossed or debossed in order to improve the durability of the markers. Furthermore, the disks can also be embossed with Braille symbols so that they can be used by the blind.

The markers may be used to identify the different parts of one device, or multiple peripheral devices of a single system, such as a computer. The console of a computer often has many cables attached to it which can become easily confused. The markers could provide images of the peripheral equipment attached to the console such as the monitor, printer, keyboard, mouse, and speakers, which will facilitate the proper installation of the cables as well as subsequent identification.

Thus, it is an object of the present invention to assist with the identification of an electrical device.

It is also an object of the present invention to provide identification markers that can be affixed directly on the plugs of electrical devices.

Furthermore, it is an object of the present invention to provide identification markers for use on the plugs of electrical devices that incorporate universally recognized images for said devices.

Additionally, it is an object of the present invention to provide identification markers for plugs that allow for quick, on-site identification of the device to which the plug is attached without the use of remotely recorded data.

Also, it is an object of the present invention to provide a one-step process for identifying the electrical device to which a plug is attached.

Further, it is an object of the present invention to provide identification markers for use on the plugs of electrical devices which consume little space, allowing uses in tight spaces.

In addition, it is an object of the present invention to provide identification markers for the plugs of electrical devices which are visible in the dark.

It is yet another object of the present invention to provide identification markers for the plugs of electrical devices which incorporate Braille symbols.

The distinction of the invention will become further apparent to one skilled in the art after review of the following description, figures, and claims.

### BRIEF DESCRIPTION OF THE DRAWINGS

A preferred embodiment of the present invention is illustrated in the accompanying drawings in which:

FIG. 1 shows markers of the present invention which have not yet been attached to an electrical plug. The images printed on either the back or front of the disks depict a wide array of universally recognized symbols for household and office electrical appliances.

FIG. 2A shows markers of the present invention which have been embossed with images of the universally recognized symbols.

FIG. 2B shows markers of the present invention which have been debossed with images of the universally recognized symbols.

FIG. 3 shows markers of the present invention which have been embossed with Braille symbols.

FIG. 4 shows how a marker of the present invention can be attached to an electrical plug through the adhesive material on the back side of the circular disk. The marker can be attached to various locations on a standard electrical plug.

FIG. 5 shows how a marker of the present invention can be attached to a plug which is not meant to be plugged into an electrical outlet, but rather runs from one piece of equipment to another.

FIG. 6 shows individual markers of the present invention attached to the plugs of multiple electrical devices plugged into a power strip.

### DETAILED DESCRIPTION OF THE INVENTION

As required, a detailed illustrative embodiment of the present invention is disclosed herein. However, techniques and structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

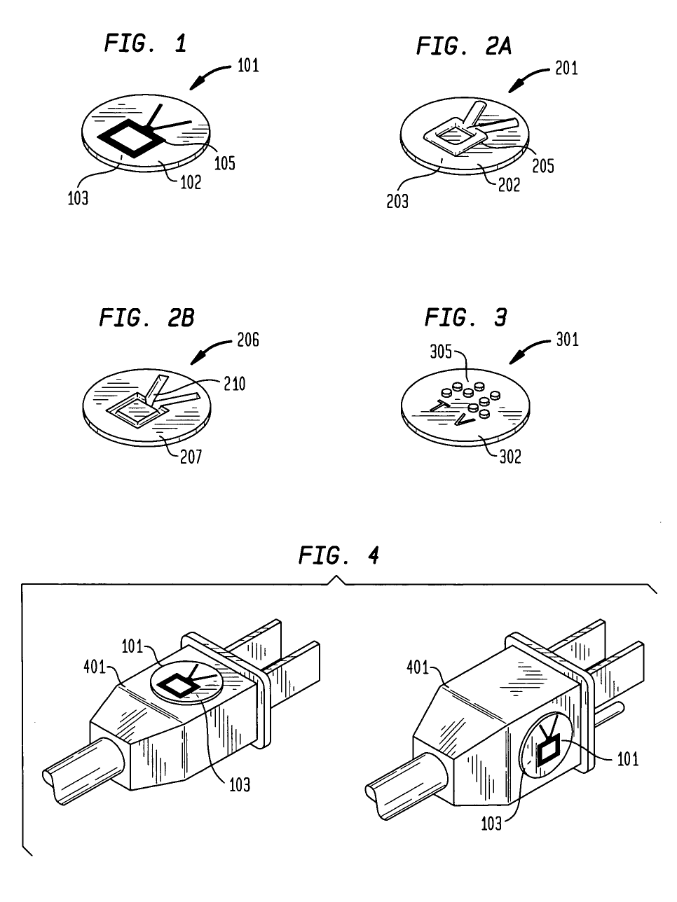

Referring now to the drawings in greater detail, FIG. 1 illustrates an identifier of the present invention before it has been attached to an electrical plug. The identifier consists of a circular disk 101 which has an image 105 printed on the front side 102 and an adhesive material on back side 103. Disk 101 may be composed of plastic selected from the group consisting of polyurethane, polycarbonate, polyethylene, polypropylene, and/or acrylic plastics. In addition, the surface of front side 102 may be flat, concave or convex to facilitate viewing of the image from multiple angles. The adhesive material on back side 103 may be selected from the group consisting of cyanoacrylate, methacrylate, epoxy, and/or acrylic adhesives. The adhesive material allows a user to affix back side 103 of disk 101 to an electrical plug while allowing image 105 on front side 102 to remain in view.

Image 105 on the markers will depict an assortment of universally recognized symbols for household, office, and industrial electrical apparatuses. Such images could include a television, lamp, printer, toaster, computer, copier, telephone, or clock among many other electrical devices. Disk 101 will be small enough to fit comfortably on an electrical plug but large enough so that image 105 on front side 102 can be easily recognized from a reasonable distance. In addition, the background of image 105 can be printed with luminescent ink so that the images can be visible in areas with little or no light. Or alternatively, disk 101 can be composed of a material that incorporates a luminescent substance so that the surface of disk 101 is illuminated in the dark. The luminescent feature is useful because the markers may need to identify plugs located in poorly lit areas.

FIG. 2A shows an embodiment of the invention where universally recognized image 205 is embossed on front side 202 of circular disk 201 so that it can be easily viewed from many different angles. Image 205 may also be both printed and embossed on front side 202 to improve the durability of the markers. The embossment of image 205 will make the markers more durable because a person can still identify image 205 even if the ink used to print the image has worn off.

FIG. 2B shows another embodiment of the invention where universally recognized image 210 is debossed on front side 207 of circular disk 206. Image 210 may also be both printed and debossed on front side 207 to improve the durability of the markers because a person can still identify image 210 even if the ink used to print the image has worn off.

FIG. 3 depicts an alternative embodiment of the invention which can be used by the blind. Image 305 on front side 302 of circular disk 301 is embossed in Braille so the user can identify the device by touch.

FIG. 4 shows the different ways in which the present invention can be attached to an electrical plug. The user will choose the appropriate location on plug 401 for the marker so that it can be easily viewed when attached. Because the marker is attached to plug 401 by an adhesive material on back side 103 of circular disk 101, the marker will stay fixed at the location until the user decides to remove it. Once attached, the marker consumes very little space so that it can be easily used on plugs which are bundled together at an outlet or surge protector. In addition, the marker is not bulky in design so a user will not be confused by multiple different markers used in one central location.

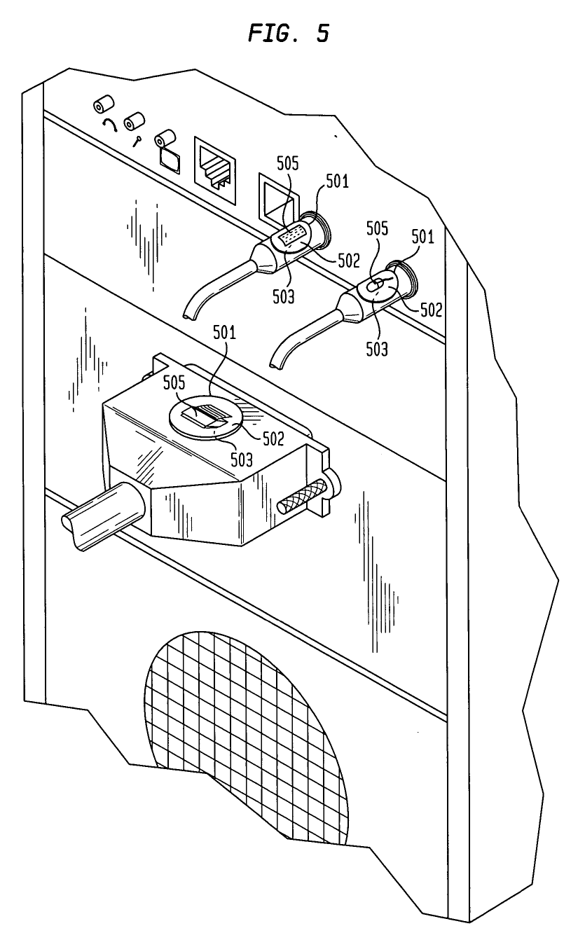

FIG. 5 depicts an alternative embodiment of the invention which can be used to identify plugs associated with household and office appliances which run from those appliances to their associated peripherals. The markers each consist of a circular disk 501 which has an image 505 printed on either the back or front side 502 and an adhesive material on back side 503. The markers can be used to identify plugs for appliances with multiple cables such as peripheral computer or home entertainment equipment, where the plugs are not inserted into an electrical outlet, but rather connect a cord from one system component to another. Image 505 on the markers will depict an assortment of universally recognized symbols for the devices associated with the plugs. For example, if the markers are being used for the console of a computer, then image 505 could include a monitor, keyboard, printer, mouse, or speakers among other electrical devices. The markers will help reduce confusion in the future when servicing or replacing the devices attached to the console of the computer.

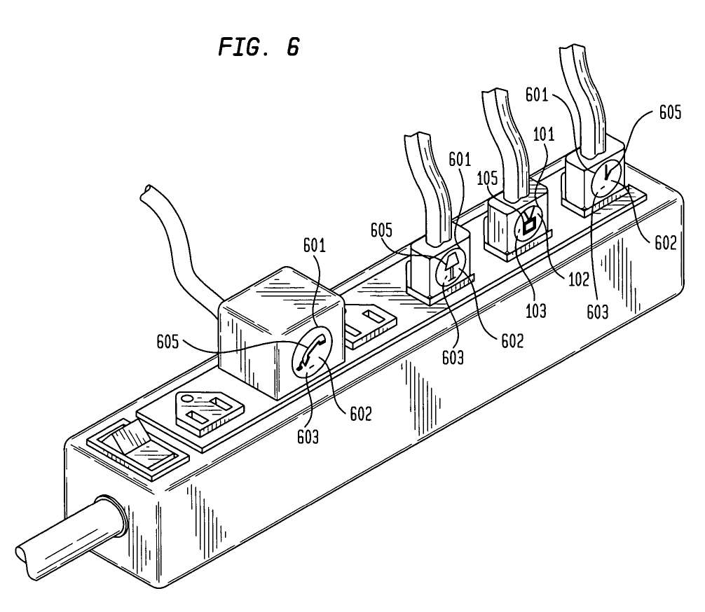

FIG. 6 illustrates how the present invention can be utilized with a power strip. The markers each consist of a circular disk 601 which has an image printed on either the back or front side 602 and an adhesive material on back side 603. Image 605 on the markers will depict an assortment of universally recognized symbols for the devices associated with the plugs. The markers will readily identify each electrical device and help reduce confusion when a user wishes to unplug a particular item from the power strip.

Another embodiment of the present invention can involve embossing or printing the images of the electrical devices directly onto an electrical plug. This design removes the need for adhesive disks because the images are incorporated into the plugs during the manufacturing process. Appliance manufacturers may choose to incorporate device-identifying images onto their plugs at the time of production to improve the functional design of their products. This will be especially useful for manufacturers of multiple electrical devices which may be used in conjunction with one another. For example, home theater systems are often composed of a television, a DVD player, speakers, a receiver, and other devices which all have their own electrical plug. The image on the plug will help identify the plug for each component when it needs to be unplugged, and avoid the confusion caused by one or many other plugs that are otherwise identical or similar in appearance. Such an embodiment of the invention will be attractive to appliance manufacturers because it will make their products more functional and design complete.

While the present invention has been described with reference to a preferred embodiment (as well as some variants thereof), which have been set forth in considerable detail for the purposes of making a complete disclosure of the invention, such an embodiment is merely exemplary and is not intended to be limiting or to represent an exhaustive enumeration of all aspects of the invention. The scope of the invention, therefore, shall be defined solely by the following claims as attached or as subsequently amended. Further, it will be apparent to those of skill in the art that numerous changes may be made in such details without departing from the spirit and the principles of the invention.

1. A device to aid in the identification of an electrical device comprising:
a disk which has both a front side and a back side;
an adhesive material applied to said back side of said disk;
an image placed on either the back or front side of said disk.

2. A device according to claim 1 wherein said disk is attached to a plug of said electrical device.

3. A device according to claim 1 wherein said image is selected from the group consisting of symbols representing household, office, and industrial electronic devices.

4. A device according to claim 1 wherein said image placed on said disk via printing in ink on said disk.

5. A device according to claim 4 wherein said ink has luminescent properties.

6. A device according to claim 1 wherein said image is placed on said disk via embossing said image on said front side of said disk.

7. A device according to claim 1 wherein said image is placed on said disk via debossing said image on said front side of said disk.

8. A device according to claim 1 wherein said image is selected from the group consisting of Braille symbols.

9. A device according to claim 1 wherein said disk is composed of a plastic material.

10. A device according to claim 9 wherein said plastic material is selected from the group consisting of polyurethane, polycarbonate, polyethylene, polypropylene, and/or acrylic plastics.

11. A device according to claim 1 wherein said disk is composed of a material with luminescent properties.

12. A device according to claim 1 wherein said adhesive material is selected from the group consisting of cyanoacrylate, methacrylate, epoxy, and/or acrylic adhesives.

13. A device according to claim 1 wherein said front side of said disk is flat.

14. A device according to claim 1 wherein said front side of said disk is concave.

15. A device according to claim 1 wherein said front side of said disk is convex.

16. A device according to claim 2 wherein said plug is the connector plug of a peripheral device associated with said electrical device.

17. A method to aid in the identification of an electrical device comprising the steps of:
labeling a plug with a marker which contains an image of that electrical device;
identifying said electrical device by viewing said marker on said plug.

18. A method according to claim 17 wherein said marker is comprised of:
a disk which has both a front side and a back side;
an adhesive material applied to said back side of said disk;
an image placed on either the back or front side of said disk.

19. A method according to claim 18 wherein the means for labeling said plug with said disk is comprised of attaching said back, adhesive side of said disk to said plug.

20. A method according to claim 18 wherein the means for identifying said plug using said disk is comprised of referring to said image on said front side of said disk.

21. A device according to claim 17 wherein said plug is the electrical plug for said electrical device.

22. A method according to claim 18 wherein said image is selected from the group consisting of symbols representing household, office or industrial electronic devices.

23. A method according to claim 18 wherein said image is placed on said disk via printing in ink on said disk.

24. A method according to claim 23 wherein said ink has luminescent properties.

25. A method according to claim 18 wherein said image is placed on said disk via embossing on said front side of said disk.

26. A method according to claim 18 wherein said image is placed on said disk via debossing on said front side of said disk.

27. A method according to claim 18 wherein said image is selected from the group consisting of Braille symbols.

28. A method according to claim 18 wherein said disk is composed of a plastic material.

29. A method according to claim 28 wherein said plastic material is selected from the group consisting of polyurethane, polycarbonate, polyethylene, polypropylene, and/or acrylic plastics.

30. A method according to claim 18 wherein said disk is composed of a material with luminescent properties.

31. A method according to claim 18 wherein said adhesive material is selected from the group consisting of cyanoacrylate, methacrylate, epoxy, and/or acrylic adhesives.

32. A method according to claim 18 wherein said front side of said disk is flat.

33. A method according to claim 18 wherein said front side of said disk is concave.

34. A method according to claim 18 wherein said front side of said disk is convex.

35. A device to aid in the identification of an electrical device comprising
a plug, and
an image of said electrical device being placed on said plug.

36. A device according to claim 35 wherein said image is placed on said plug via printing in ink on said plug.

37. A device according to claim 35 wherein said image is placed on said plug via embossing on said plug.

38. A device according to claim 35 wherein said image is placed on said plug via debossing on said plug.

39. A device according to claim 35 wherein said image is selected from the group consisting of symbols representing household, office and industrial electronic devices.

40. A device according to claim 35 wherein said image is selected from the group consisting of Braille symbols.

41. A device according to claim 36 wherein said ink has luminescent properties.
